(19) United States
(12) Patent Application Publication
(10) Pub. No.: US 2008/0113712 A1
(43) Pub. Date: May 15, 2008

(54) Turnable input device for a game of chance and a method for providing thereof

(76) Inventors: Aline Leblanc, Moncton (CA); Jeffrey Prescesky, Dieppe (CA)

Correspondence Address: KENYON & KENYON LLP, ONE BROADWAY, NEW YORK, NY, 10004, US

(21) Appl. No.: 11/598,939

(22) Filed: Nov. 13, 2006

(51) Int. Cl. G06F 17/00

(52) U.S. Cl. 463/16; 463/25

(57) ABSTRACT

A gaming terminal and method for providing a wagering game are provided. The gaming terminal may include a turnable input device movably attached to the terminal, the turnable input device configured to provide a first input when turned by a player. The gaming terminal may include a video display attached to the terminal, in communication with the turnable input device, the video display configured to display a turning element in the wagering game which turns responsive to the first input.

A portion of the disclosure of this patent document contains material which is subject to copyright protection. The copyright owner has no objection to the facsimile reproduction by anyone of the patent document or patent disclosure as it appears in the Patent and Trade-mark Office patent file or records, but otherwise reserves all copyright rights whatsoever.

### BACKGROUND

Games of chance may be offered through an automated machine, such as a video slot machine, a video lottery terminal, or a video gaming machine. A video slot machine replaces the mechanical reels of a traditional slot machine with a video display, such as a CRT or LCD display. The display simulates the reels of a traditional slot machine by displaying a plurality of elements. Each element may depict a symbol and the elements may be animated to simulate spinning reels after a lever on the side of the machine is pulled.

A video lottery terminal may provide a lottery game to players by providing a video terminal where players can buy tickets, view a list of available prizes, and handle basic customer service transactions. Other lottery games may be played directly on a display screen of a video terminal. Video lottery terminals may include a cabinet enclosing internal hardware and a display screen visible to a player. Internal hardware may include hardware and software controls for playing a wagering game, such as a lottery game. Information may be displayed on the display screen. For example, the provided controls can cause a display of the lottery tickets available, attractive animation sequences to promote sales, and accept a selection of lottery tickets from the player to purchase.

Many other wagering games may also use a video gaming machine. For example, a video gaming machine may be configured to provide a game of video poker. The provided controls may cause cards to be displayed on the screen, along with other game play information such as bet information and a prize structure for particular poker hands. Other wagering games that may use a video gaming machine include video blackjack machines.

Such gaming machines may include a plurality of input devices. An input device is configured to receive an input from a player and communicating the input to the gaming machine. Traditional video slot machines include input devices such as buttons. Some video gaming machines include input devices such as a mouse-type pointing device or a touch-sensitive display screen.

### BRIEF DESCRIPTION OF THE DRAWINGS

FIG. 1A illustrates an example embodiment of a first input device, in accordance with an example embodiment of the present invention.

FIG. 1B illustrates a profile view of the first input device, in accordance with an example embodiment of the present invention.

FIG. 2A illustrates a view of a second input device, in accordance with an example embodiment of the present invention.

FIG. 2B illustrates a view of a third input device, in accordance with an example embodiment of the present invention.

FIG. 2C illustrates an example input panel including the second input device, in accordance with an example embodiment of the present invention.

FIG. 2D illustrates an example screen shot at a terminal in a wagering game, in accordance with an example embodiment of the present invention.

FIG. 3 illustrates an example system for providing a wagering game, in accordance with an example embodiment of the present invention.

FIG. 4 illustrates an example video gaming machine, in accordance with an example embodiment of the present invention.

FIG. 5 illustrates an example procedure for providing a wagering game, in accordance with an example embodiment of the present invention.

FIG. 6 illustrates an example procedure for receiving a game option or parameter modification command, in accordance with an example embodiment of the present invention.

FIG. 7 illustrates an example system schematic of an input device with a turnable surface, in accordance with an example embodiment of the present invention.

### DETAILED DESCRIPTION OF EXAMPLE EMBODIMENTS

An example embodiment of the present invention may include a turnable input device on a gaming machine. The input device may be configured to turn around at least one axis. In addition, the input device may also be spinnable or rotatable. The input device may be configured to provide a first input when it is spun by the player, which is received by the gaming machine. The gaming machine may, responsive to the first input, display a turning element on a display. The input device may also be configured to provide a second input when it stops turning. The game machine may, responsive to the second input, stop turning the displayed element. The input device may increase customer interest by allowing customers to start or stop a turn, which may then be reflected by starting or stopping a turning element on a video display.

An example embodiment of the present invention may include a gaming terminal for a wagering game. The gaming terminal may include a turnable input device movably attached to the terminal, the turnable input device configured to provide a first input when turned by a player. The gaming terminal may include a video display attached to the terminal, in communication with the turnable input device, the video display configured to display a turning element in the wagering game which turns responsive to the first input. The terminal may be configured to, responsive to receiving the first input, display the outcome of a wager made by the player. The turnable input device may be configured to provide a second input when the turnable input device stops turning, and the video display is configured to stop the turning element responsive to the second input. The terminal may be configured to determine an outcome of a wager made by the player and stop the turning element at a result indicative of the outcome. The turning element may be an animated turning wheel, a simulated slot machine reel, a simulated roulette wheel, or a simulated lock element. The turnable input device may be further configured to turn around an axis perpendicular to a surface of the terminal. The turnable input device may be further configured to provide a third input when pushed towards the terminal along an axis perpendicular to a surface of the terminal. The first input may modify a game speed, a game music volume, a user selection of play lines in the wagering game, or a user selection of a wager amount in the wagering game. The gaming terminal may also include a payment acceptor configured to receive a payment from the player. The gaming terminal may also include a prize structure configured to associate game outcomes with prizes. The gaming terminal may also include a prize dispenser configured to award a prize to the player.

Another embodiment of the present invention may include a method of facilitating play of a game of chance at a terminal. The method may include receiving a first input indicating a player has turned a turnable input device. The method may include responsive to the first input, causing a displayed element on a video display to turn. The method may include initiating resolution of a wager responsive to receiving the first input. The method may include receiving a second input when the turnable input device stops turning, and responsive to the second input, stopping the turning of the displayed element. The method may include determining an outcome for the wager and wherein the displayed element is stopped on a result indicating the outcome. The displayed element may be an animated turning wheel, an animated roulette wheel, a simulated slot machine reel, or a simulated lock element. The turnable input device may be configured to turn around an axis perpendicular to a surface of the terminal. The turnable input device may be further configured to provide a third input when pushed towards the terminal along an axis perpendicular to a surface of the terminal. The first input may modify a game speed, a game music volume, a user selection of play lines in the wagering game, or a user selection of a wager amount in the wagering game. The method may include receiving a payment from the player at a payment acceptor. The method may include determining a prize to be awarded by looking up a prize structure that associates game outcomes with prizes. The method may include awarding a prize to the player from a prize dispenser.

Another embodiment of the present invention may include a computer readable medium including instructions configured to be executed on a processor, so that the processor performs a method of facilitating play of a game of chance at a terminal. The method may include receiving a first input indicating a player has turned a turnable input device. The method may include responsive to the first input, causing a displayed element on a video display to turn.

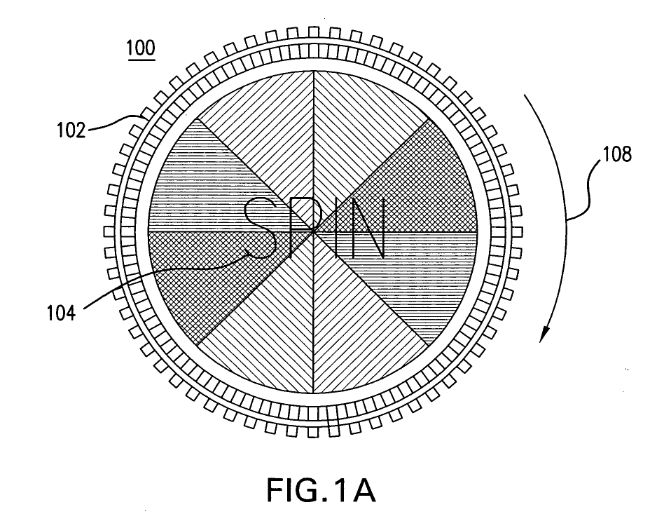

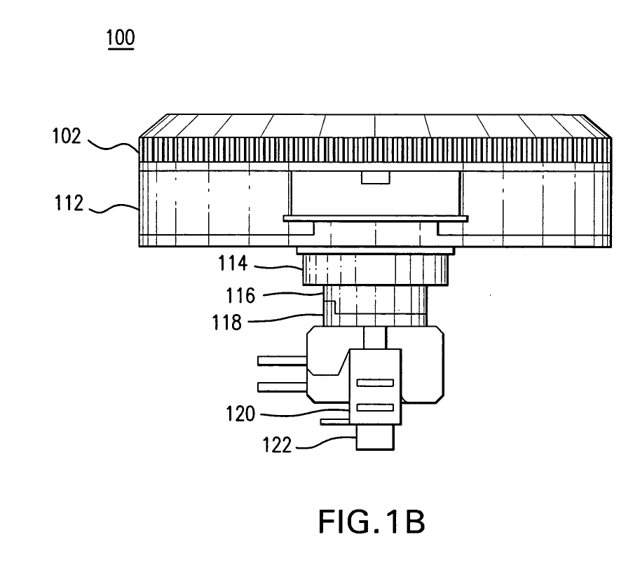

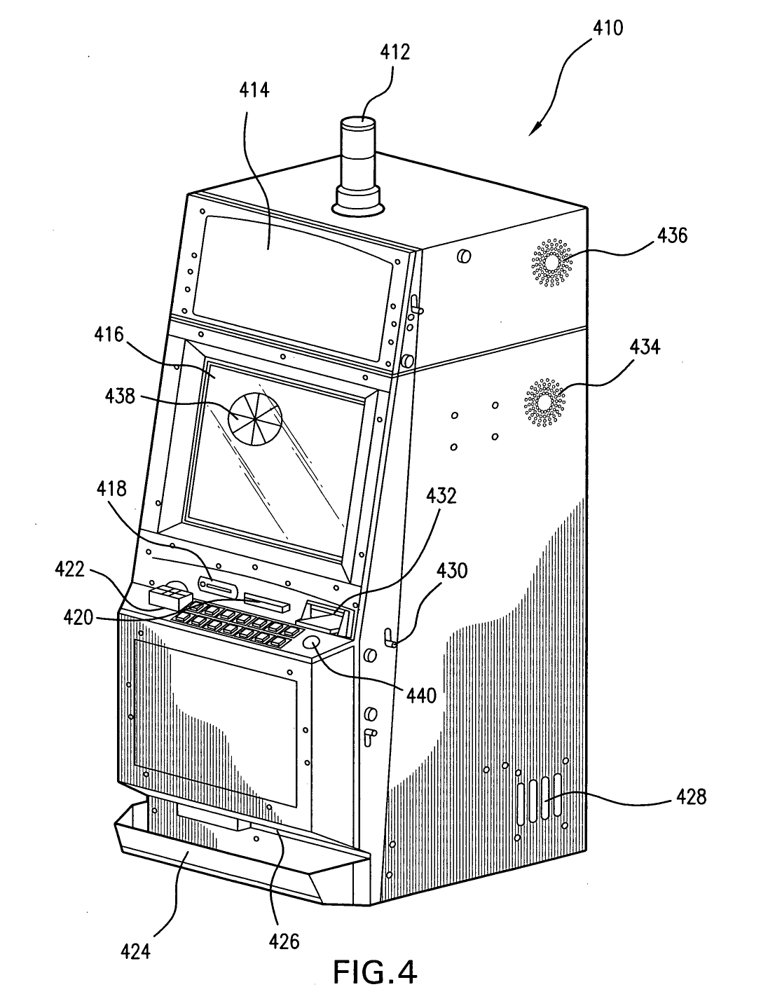

FIG. 1A illustrates an example embodiment of a first input device, in accordance with an example embodiment of the present invention. For example, the first input device may be an input device on a gaming machine as depicted in FIG. 4. Although depicted as a wheel, it is understood that the first input device may be non-circular or asymmetric. The wheel 100 may be turnable, spinnable, or rotatable about an axis extending out from a surface. The whole wheel 100 may be turnable, or just an outer rim. For example, the wheel 100 may be bidirectional.

The wheel 100 may include a textured surface 102 around the edge of the wheel configured to be gripped by a player. The player may grip the textured surface 102, for example, with his hand, and spin the wheel 100 around the axis when a force provided by a typical player is applied. The wheel 100 may be configured to spin for multiple of revolutions before stopping. The expected length of the spin may depend on the force applied; although friction may increase or decrease the amount of spin obtained by a typical player. The wheel 100 may also be configured to allow the player to keep spinning the wheel 100, although if desired, this may be discouraged by detecting additional force applied to the wheel 100 and messaging the player.

In an alternative embodiment, the wheel 100 may be configured to rotate. The wheel 100 may rotate a small distance when the textured surface 102 is gripped by the player and rotated. The wheel 100 may be configured to stop rotating when the player stops applying rotational force. The wheel 100 may be configured to spin for multiple of revolutions before stopping.

In an alternative embodiment, the wheel 100 may be configured to both spin and rotate. For example, the wheel 100 may be configured to spin when a large force is applied to it, and rotate when a small force is applied to it.

The wheel 100 may include a lateral surface 104 (not depicted). The lateral surface 104 may be a foundation onto which the textured surface 102 is attached. The lateral surface 104 may be decorated with visually attractive graphics or other images. The player may grip the textured surface 102, for example, with his hand, and spin the wheel 100 around the axis.

The lateral surface 104 may include a display screen, such as an LCD screen, for displaying graphics. The LCD screen may be configured to display attractive graphics to the player, game information, or other information. The lateral surface 104 may include a visual reference to indicate an ending position. For example, the ending position may be used in the wagering game to determine an outcome.

FIG. 1B illustrates a profile view of the first input device, in accordance with an example embodiment of the present invention. For example, the first input device may be an input device on a gaming machine as depicted in FIG. 4. The wheel 100 may be as depicted in FIG. 1A. The wheel 100 may be spinnable or rotatable about an axis extending out from a surface. For example, the wheel 100 may revolve in a first direction 108, for example, clockwise. Alternatively, the wheel 100 may revolve in a second direction around the axis, for example, counterclockwise.

The wheel 100 may include a textured surface 102 around the edge of the wheel. The textured surface 102 may be configured to be gripped by a player. The player may grip the textured surface 102, for example, with his hand, and spin the wheel 100 around the axis. The wheel 100 may be configured to freely spin for a random number of revolutions before stopping. Alternatively, a toggle or other mechanism may slow, stop, or limit rotation of the wheel 100.

The wheel 100 may include a body 112. For example, the body 112 may be attached to the back of the lateral surface depicted in FIG. 1A. The body 112 may provide bulk, weight, and strength to the wheel 100. The body 112 may be constructed from a plastic, a polymer, a metal, a fastener, or some other rigid or semi-rigid material.

The wheel 100 may include a backing mount 114. The backing mount 114 may be fixedly attached to the body 112. For example, the backing mount 114 may be attached to the body 112 by nails, screws, or snapped into integrated attachment locations.

The wheel 100 may include a rotating joint 116. The rotating joint 116 may be configured to spin or rotate both. One end of the rotating joint 116 may be fixedly attached to the backing mount 114.

The wheel 100 may include a base 118. The second end of the rotating joint 116 may be fixedly attached to the base 118, so that the wheel 100 may spin or rotate relative to the base 118.

The wheel 100 may include a data cable interface 120. The data cable interface 120 may detect revolutions in the rotating joint 116 and convert the movement into electric signals configured to be carried over a data cable.

The wheel 100 may include a data cable jack 122. The data cable jack 112 may be configured to receive a data cable. The data cable jack 122 may be in communication with the data cable interface 120 and be configured to carry the electric signal from the data cable interface 120 to a data cable. For example, the data cable may be plugged into the data cable jack 122.

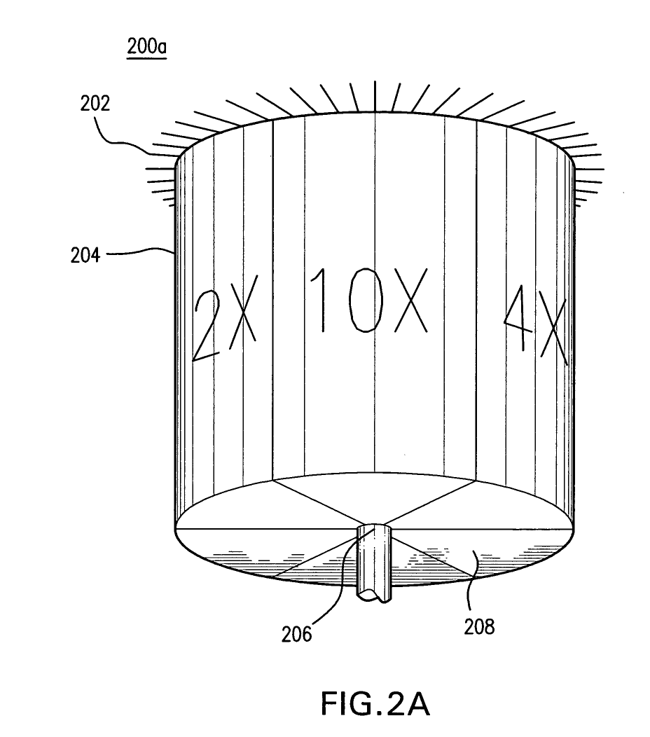

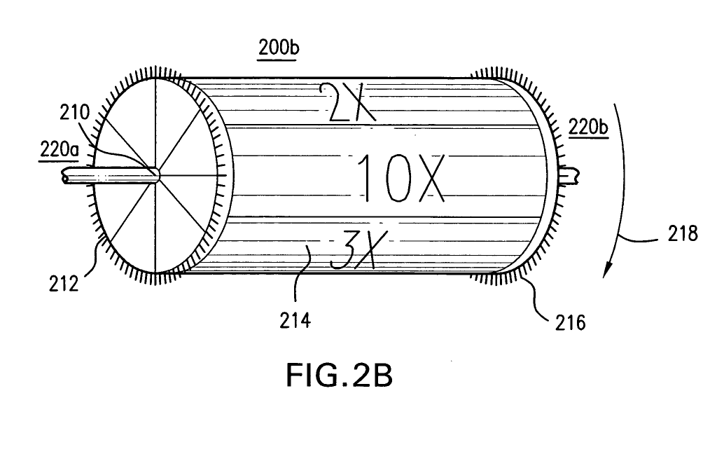

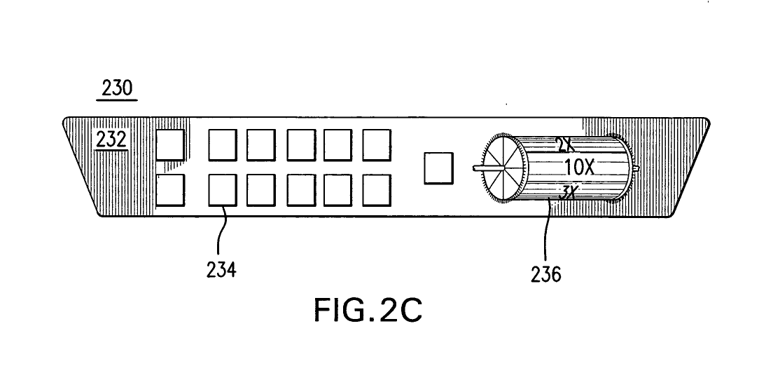

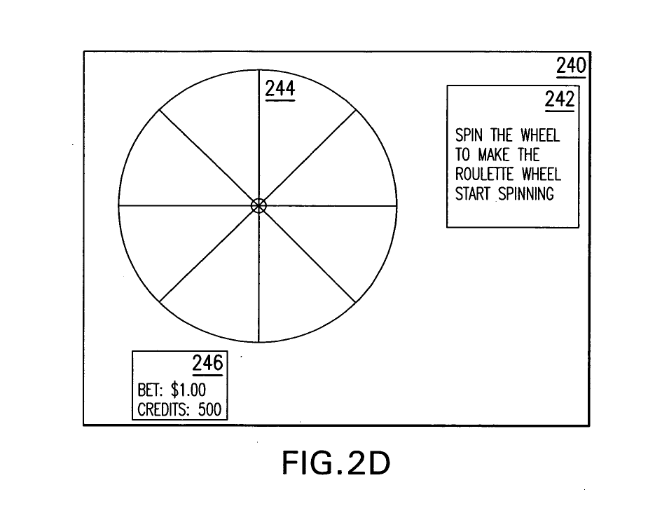

FIG. 2A illustrates a view of a second input device, in accordance with an example embodiment of the present invention. For example, the second input device may be provided as a player input device on a gaming machine as depicted in FIG. 4. The wheel 200a may be configured to rotate around a vertical axis, for example, to the left or to the right. The vertical axis may be relative to a mounting surface of a video gaming machine the second input device is mounted on.

The wheel 200a may include a rim 202 around the edge of the wheel configured to be gripped by a player. The rim 202 may be a textured surface configured to facilitate gripping by the player in turning the wheel 200a. Alternatively, the rim 202 may be a series of LED lights that create a visually attractive pattern, for example, by blinking. The player may grip the rim 202, for example, with his hand, and spin the wheel 200a around the axis. The wheel 200a may be configured to spin for multiple revolutions before stopping.

In an alternative embodiment, the wheel 200a may be configured to rotate. The wheel 200a may rotate a small distance when the rim 202 is gripped by the player and rotated. The wheel 200a may be configured to stop rotating when the player stops applying rotational force.

In an alternative embodiment, the wheel 200a may be configured to both spin and rotate. For example, the wheel 200a may be configured to spin when a large force is applied to it, and rotate when a small force is applied to it.

The wheel 200a may include a lateral surface 204. The lateral surface 204 may be a foundation onto which the rim 202 is attached. The lateral surface 204 may be decorated with visually attractive graphics or other images.

The wheel 200a may rotate around an axis 206. For example, the axis 206 may be a rotating bar attaching the wheel 200a to a gaming machine configured to allow the wheel 200a to rotate or spin.

The wheel 200a may include a wheel body 208. The wheel body 208 may be constructed from a plastic, a polymer, a metal, or any rigid or semi-rigid material. The wheel body 208 may provide the wheel 200a with rigidity, weight, and strength.

It will be appreciated that an outcome of a wager or a result of the game may not necessarily be reflected on the second input device. For example, the wheel 200a has visible results 2×, 10×, and 4×. In an alternative embodiment, the wheel 200a may be blank without visible results on its surface.

FIG. 2B illustrates a view of a third input device, in accordance with an example embodiment of the present invention. For example, the third input device may be provided as a player-input device on a gaming machine as depicted in FIG. 4. The wheel 200b may be configured to rotate around a horizontal axis, for example, up or down.

The wheel 200b may include a textured surface 216 around the edge of the wheel configured to be gripped by a player. The player may grip the textured surface 216, for example, with his hand, and spin the wheel 200b around the axis, for example, downwards in direction 218. The wheel 200b may be configured to spin for a random number of revolutions before stopping.

In an alternative embodiment, the wheel 200b may be configured to rotate. The wheel 200b may rotate a small distance when the textured surface 216 is gripped by the player and rotated. The wheel 200b may be configured to stop rotating when the player stops applying rotational force.

In an alternative embodiment, the wheel 200b may be configured to both spin and rotate. For example, the wheel 200b may be configured to spin when a large force is applied to it, and rotate when a small force is applied to it.

The wheel 200b may include a lateral surface 214. The lateral surface 214 may be a foundation onto which the textured surface 216 is attached. The lateral surface 214 may be decorated with visually attractive graphics or other images.

The wheel 200b may rotate around an axis 210. For example, the axis 210 may be a rotating bar attaching the wheel 200b to a gaming machine configured to allow the wheel 200b to rotate or spin.

The wheel 200b may include a wheel body 212. The wheel body 212 may be constructed from a plastic, a polymer, a metal, or any rigid or semi-rigid material. The wheel body 212 may provide the wheel 200b with rigidity, weight, and strength.

The wheel 220b may be movably attacked to an axle 220a and 220b. For example, the axle 220a and 220b may be a single axle running through the center of the wheel 200b so that the wheel 200b may turn in direction 218.

The axle may include sensors to detect turning of the wheel 220b. The sensors may be configured to detect a direction of turning, a speed of turning, and any other information about the turning of the wheel 220.

FIG. 2C illustrates an example input panel including the second input device, in accordance with an example embodiment of the present invention. An input panel 230 may be installed on a terminal depicted in FIG. 4 and accessible to a player. The input panel 230 may include a plurality of inputs, including buttons and other inputs, to receive inputs from the player.

The input panel 230 may include a front panel 232. The front panel 232 may be made from any rigid or semi-rigid material and include cutouts for input devices. Instructions may be printed on the front panel 232 regarding use of the input devices. Graphics may be printed on the front panel 232 to attract player attention.

The input panel 230 may include input devices 234. For example, input devices 234 may be buttons, pointer devices, joy sticks, touch pad, or any other device configured to receive input from the player.

The input panel 230 may include a turnable input device 236. For example, the turnable input device 236 may as depicted in FIGS. 1A, 1B, 2A, and 2B.

FIG. 2D illustrates an example screen shot at a terminal in a wagering game, in accordance with an example embodiment of the present invention. A screen 240 may be displayed on a display of a terminal as depicted in FIG. 4. The terminal may include a turnable input device as depicted in FIGS. 1A, 1B, 2A, and 2B.

The screen 240 may include instructions 242. The instructions 242 may instruct the player to turn a turnable input device attached to the terminal.

The screen 240 may include a displayed element 244. The displayed element 244 may be, for example, a virtual roulette wheel for use in a video roulette wagering game at the terminal. The displayed element 244 may be animated to simulate turning of the virtual roulette wheel responsive to the player turning the turnable input device.

The screen 240 may include a bet and credit information 246. The bet and credit information 246 may indicate what the current bet or wager is for the current game. The bet and credit information 246 may also indicate a credit balance of the player, which may be redeemed for prizes such as merchandise, currency, or currency equivalent.

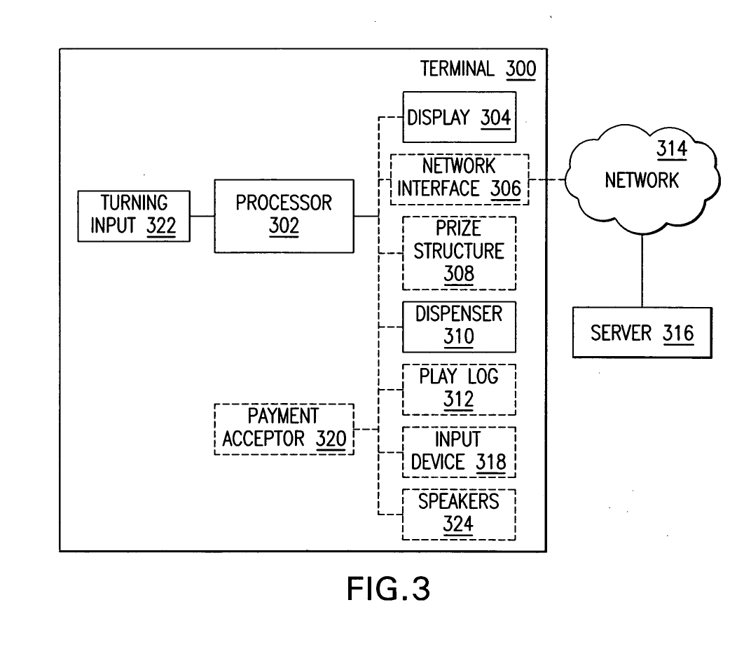

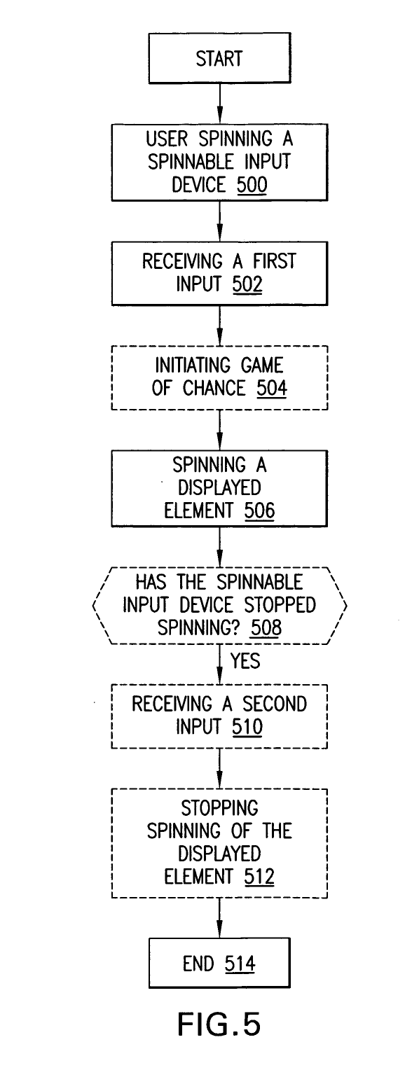

FIG. 3 illustrates an example system for providing a wagering game, in accordance with an example embodiment of the present invention. For example, the system may include a terminal 300 which may be a VST as depicted in FIG. 4. The VST may be configured to execute the procedure depicted in FIG. 5. For example, the machine may be a GTech® Aura®, WinWave™, PowerStation 5®, or PowerStation® Plus gaming machine, available through Spielo.

The terminal 300 may include a processor 302. The processor 302 may be configured to execute the procedure depicted in FIG. 5. The processor 302 may be configured to provide screen shots to a display 304 in any standard display format, for example, conventional video output formats.

The terminal 300 may include a display 304. The display 304 may be configured to display visual outputs in the wagering game to the player. Alternatively, the display 304 may be a touch-sensitive screen and function as an input as well as a display.

The terminal 300 may optionally include a network interface 306. The network interface 306 may be configured to communicate between the terminal 300 and a network. For example, the network interface 306 may be an Ethernet adaptor, a modem, or some other communication adaptor for converting information from the processor 302 into a form that can be carried over a communications network.

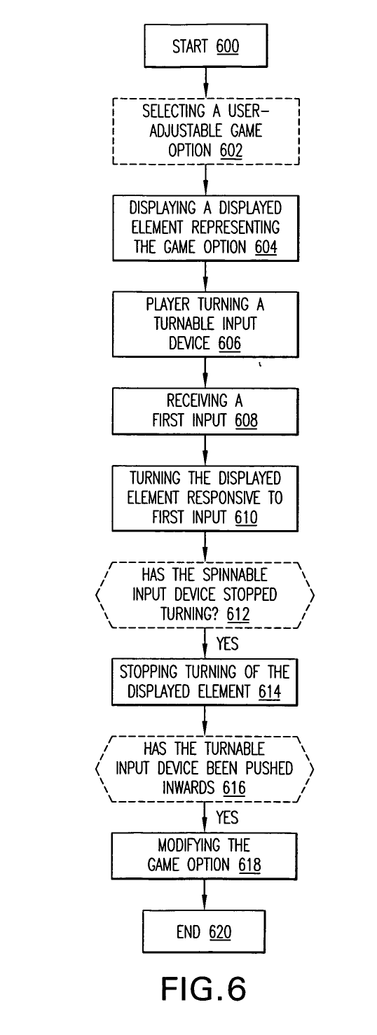

The terminal 300 may optionally include a prize structure 308, for example, as a data structure containing various information regarding prize odds and stored in a computer-readable medium. For example, the prize structure may be stored on a hard drive, a flash drive, random access memory, or any other medium readable by the terminal. The prize structure 308 may include the prizes awarded in the game as well as winning patterns associated with each prize. For example, the prize structure 308 may include symbols that must be displayed in the elements on the VST's display, as well as how they are arranged along predefined lines. For example, the prize structure 308 may include information depicted in FIGS. 6A and 6b.

The terminal 300 may include a dispenser 310. The dispenser 310 may award the player's prize when the player elects to cash out of the game. The dispenser 310 may be configured to dispense currency, such as coins, to award the prize. Alternatively, the dispenser 310 may be a printer configured to print a voucher redeemable at a cashier for the prize. Alternatively, the dispenser 310 may be configured to dispense merchandise or other physical goods as the prize. Alternatively, the dispenser 310 may be configured to dispense any suitable prize.

The terminal 300 may optionally include a play log 312. The play log 312 may be a log maintained by the terminal 300 of transactions. For example, transactions may include wagers provided to the terminal 300, prizes dispensed by the terminal 300, winning and non-winning spin results, a bet amount, selected predefined lines, a date and time of a virtual wheel spin, a frequent player identification, or any other information pertaining to the operation of the terminal 300.

For example, the information may be used for maintenance or audit purposes by the operator of the terminal 300. The terminal 300 may require maintenance after a predefined quantity of virtual spins or a predefined quantity or amount of prizes awarded. The operator of the terminal 300 may review the information to audit the performance of the game, for example, by checking for unusual patterns of prizes being awarded.

The terminal 300 may include an input device 318, such as a keypad, buttons, pointing device, scrolling wheels, or other conventional input devices. The input device 318 may be configured to receive inputs from the player required during the game.

It is understood that the terminal 300 may include more than one input device, though only one is depicted.

In an alternative embodiment, the display 304 may be a touch-sensitive screen which receives player inputs via the player touching the screen on displayed virtual buttons. In this example embodiment, an input device 318 may not be required.

The terminal may optionally include a payment acceptor 320. The payment acceptor 320 may be configured to accept a payment from the player. For example, payment may be in the form of currency (bills or coins), a magnetic card, a ticket or a printed voucher. For example, the magnetic card may be a credit card, a debit card, or another storage medium of value (such as a proprietary debit card offered by the operator of the terminal).

The terminal may include a turning input device 322. For example, the turning input device 322 may be an additional input device available to receive input from the player. For example, the turning input device 322 may be as depicted in FIGS. 1A, 1B, 2A, and 2B.

In an alternative embodiment, the turning input device 322 may be used as a standard input device. The turning input device 322 may be turned by the player and the input is used in the wagering game in a standard manner, for example, by changing a game option such as selecting between several player choices.

The terminal may include speakers 324 which are configured to produce an audio output to the player. For example, the speakers 324 may provide audio feedback responsive to input received from the player through the turning input device 322.

The terminal 300 may be in communication with a server 316 over a network 314. The network 314 may be any communications link that may carry communications between the terminal 300 and the server 316. For example, the network 314 may be an Ethernet network, a local area network, a wide area network, a virtual private network over another network, the Internet, or any other network which can carry communications.

The server 316 may be a central server located at a location remote from the terminal 300. The server 316 may coordinate a plurality of terminals (not depicted) in the system distributed at multiple locations. The server 316 may function to centralize control of the terminals.

It will be understood that functionality included in the terminal 300 may be moved to the server 316 while remaining within the scope of this specification. For example, the processor 302, the prize structure 308, the play log 312 may be located at the server 316.

It will be understood that the system may be a standalone terminal, without the network 314 or the server 316. A standalone terminal may be used when establishing a communication connection over a network to a server is cost-prohibitive or otherwise undesirable.

FIG. 4 illustrates an example video gaming machine, in accordance with an example embodiment of the present invention. For example, the machine may be a GTech® Aura®, WinWave™, PowerStation 5®, or PowerStation® Plus gaming machine, available through Spielo. A video gaming machine 410 may be configured to conduct a wagering game. For example, a wagering game may be a slot machine game, a lottery, a video game, or another game of chance involving a wager. For example, the video gaming machine 410 may be a video poker game terminal, a video wagering game terminal, a video slot machine terminal (VST), a video slot machine, or a video game terminal. The video gaming machine 410 may be in communication with a server. Alternatively, the video gaming machine 410 may be a mechanical reel slot machine terminal.

The video gaming machine 410 may include a blinker 412. The blinker 412 may enclose a light source configured to blink on and off. For example, the blinker 412 may be configured to blink when a large prize is awarded from the video gaming machine 410.

The video gaming machine 410 may include a lighted display 414. For example, the lighted display 414 may include a logo, a game name or other visually attractive graphics. The lighted display 414 may alternatively be a liquid crystal display screen. For example, the lighted display 414 may be configured to display graphics and text.

The video gaming machine 410 may include a display screen 416. For example, the display screen 416 may be a liquid crystal display screen (LCD) or a cathode ray tube (CRT) screen. For example, the display screen 416 may enclose a viewable display area visible to a player. Alternatively, the display screen 416 may be a touch screen, configured to accept player inputs of touching the screen.

The video gaming machine 410 may include a player's card accepter 418, a printer 420 and a currency accepter 432. For example, the player's card accepter 418 may accept a frequent player's card. The frequent player's card may include a player's identifying information and play history. Alternatively, the frequent player's card may include an identifier that is associated with a player's identifying information and wager history. For example, the printer 420 may be configured to print a voucher or ticket for the player. The currency accepter 432 may be configured to accept cash bills in various denominations for a player's wager. The currency accepter 432 may also be configured to accept printed vouchers and tickets.

The video gaming machine 410 may include input modules 422. For example, the input modules 422 may be a set of buttons. The input modules 422 may be configured to receive input from a player during a wagering game. Other forms of input modules may be used, for example, a mouse-pointer device or a voice recognition module.

The video gaming machine 410 may include a dispenser tray 424 and a dispenser 426. The dispenser 426 may be configured to dispense a prize. For example, a prize may be currency or a prize receipt redeemable at a cashier. The dispenser tray 424 may be configured to catch the prize after it is dispensed.

The video gaming machine 410 may include openings 428, 434 and 436. Opening 428 may be configured to allow sound through. For example, interior speakers may be located behind opening 428. The openings 434 and 436 may be configured to allow ambient air to circulate into and out of an interior of the video gaming machine 410. Ambient air circulation may assist in maintaining an optimal operating temperature for the video gaming machine 410.

The video game machine 410 may include a latch 430. For example, the latch 430 may be configured to release a front door of the video game machine 410 for opening. When the front door is opened, it may be possible for a technician to access an interior of the video game machine 410 for upgrades or maintenance.

The video game machine 410 may include a displayed element 438. The displayed element 438 may simulate a turning element on the screen, for example, a roulette in a game of video roulette. Alternatively, the displayed element 438 may be an indicator displaying changes in a game option, for example, game speed or game music volume. The displayed element 438 may be animated to simulate rotation responsive to the player rotating a turning input device 440. Alternatively, the displayed element 438 may represent a user selection of play lines to be used in the wagering game, or a wager amount. Alternatively, the displayed element 438 may represent a sound track or a theme of the wagering game. Alternatively, the displayed element 438 may represent any option used in the game.

The video game machine 410 may include the turning input device 440. For example, the turning input device 440 may be an additional input device available to receive input from the player. For example, the turning input device 440 may be as depicted in FIGS. 1A, 1B, 2A, and 2B.

For example, the terminal may be a personal computer (PC) (either a standalone computer or a thin client connected to a network), a cellular phone, a personal digital assistant (PDA), a smart phone, a wireless device, a handheld device, or any other device configured to provide the wagering game to the player. The terminal may be configured to deactivate or implement a different rule set when it is moved to a jurisdiction where the wagering game is illegal or otherwise regulated.

FIG. 5 illustrates an example procedure for providing a wagering game, in accordance with an example embodiment of the present invention. The procedure may execute on a video gaming machine as depicted in FIG. 4 and a system as depicted in FIG. 3 and receive input from an input device as depicted in FIGS. 1A, 11B, 2A, and 2B.

In 500, the procedure may wait for a player to spin a spinnable input device. For example, the spinnable input device may be an input device as depicted in FIGS. 1A, 1B, 2A, and 2B. The input device may be attached to a gaming machine as depicted in FIG. 4. The input device may be part of a system as depicted in FIG. 3. The player may be playing the wagering game or game of chance provided by the gaming machine.

In 502, the procedure may receive a first input from the player. For example, the first input may be generated by the input device. For example, the first input may include a digital signal indicating whether the input device is spinning or not. The first input may also include information on how fast and what direction the input device is spinning. The first input may also include fraud-detection signals that indicate possible tampering with the input device. The first input may also include rotational information from the first input.

In 504, the procedure may optionally initiate the game of chance or wagering game. For example, the game of chance may not begin until the player spins the input device. For example, the player may be required to first select a game to play and input game parameters, such as a wager amount and other game options. The wagering game may include displayed elements displayed to the player via a display of the gaming machine.

In 506, the procedure may spin a displayed element. For example, at least one element may be displayed on a display of the gaming machine may be an animated wheel that spins in response to the first input.

For example, the displayed element may be an animated spinning wheel, an animated roulette wheel, or a simulated slot machine reel.

The spinning of the displayed element may correspond in real-time to the spinning of the input device. For example, the number and speed of revolutions undertaken by the displayed element may be approximately the same as the input device. Alternatively, the start of game and spinning may be triggered responsive to receiving input from the input device. For example, the spinning of the displayed element may correspond in direction to the spinning of the input device. If the input device is spun in one direction, the displayed element may spin in a corresponding direction.

In an alternative embodiment, the number and speed of revolutions of the input device may be ignored. The gaming machine may spin the displayed element multiple times after the first input is received regardless of the actual physical spinning of the input device.

For example, the game of chance may be a roulette game, and the displayed element may be a roulette wheel that spins responsive to the player spinning the input device. For example, the game of chance may be a spinner game involving a prize wheel, and the displayed element may be the fortune wheel that spins responsive to the player spinning the input device.

In an alternative embodiment, the input device may be configured to rotate instead or in addition to spinning. The game of chance may involve a treasure chest with a combination lock. The first input may manipulate the combination lock by turning a lock element and thus changing the lock combination.

In 508, the procedure may optionally test whether the input device has stopped spinning. If yes, the procedure may proceed to 510. If no, the procedure may wait until the input device has stopped spinning.

In 510, the procedure may optionally receive a second input from the input device. For example, the input device may provide a second input when it stops spinning. For example, the input device may stop from friction or from the player stopping the spinning.

In 512, the procedure may optionally stop spinning the displayed element. In one embodiment, the displayed element spins at the same speed as the input device, and stops when the input device stops. The result is calculated from where the input device stops.

In an alternative embodiment, the procedure may predetermine what an outcome should be when a wager is accepted from the player. The procedure may then calculate what result must be displayed by the displayed element to provide the outcome in accordance with the rules of the wagering game. In this embodiment, the outcome may be predetermined but the spinning of the input device and the displayed element may give the player an illusion that the spinning input device influences the outcome of the wagering game, when in fact the outcome is predetermined.

In 514, the procedure may end.

It will be understood that the input device may be spinnable, rotatable, turnable, or some combination of the above.

FIG. 6 illustrates an example procedure for receiving a game option or parameter modification command, in accordance with an example embodiment of the present invention. The procedure may execute on a video gaming machine as depicted in FIG. 4 and a system as depicted in FIG. 3 and receive an input from a turnable input device as depicted in FIGS. 1A, 1B, 2A, and 2B. The procedure may utilize the turnable input device to receive a player modification of a parameter. The procedure may start in 600.

In 602, the procedure optionally selects a player-adjustable game option or parameter to be modified. For example, the procedure may select a game option responsive to a player indication of a desire to change the game option. The game option may be, for example, a game speed or a game music volume. The game option may be any other player-adjustable game option available in the game of chance provided on the video gaming machine.

In 604, the procedure may display a displayed element representing the game option to the player. For example, if the game option is game speed, the display element may be an animated wheel that indicates the currently selected game speed of the video gaming machine. For example, if the game option is game music volume, the display element may be an animated wheel that indicates the currently selected game music volume of the video gaming machine.

In 606, the procedure may wait for a player to turn a turnable input device. For example, the turnable input device may be an input device as depicted in FIGS. 1A, 11B, 2A, and 2B. The input device may be attached to a gaming machine as depicted in FIG. 4. The input device may be part of a system as depicted in FIG. 3. The player may be playing the wagering game or game of chance provided by the video gaming machine. The player may turn the input by physically grasping it with his hand and applying a rotational force.

In 608, the procedure may receive a first input from the player. For example, the first input may be generated by the input device. For example, the first input may include a digital signal indicating whether the input device is turning or not. The first input may also include information on how fast and what direction the input device is turning. The first input may also include fraud-detection signals that indicate possible tampering with the input device. The first input may also include rotational information from the input device.

In 610, the procedure may spin the displayed element. The displayed element may represent the game option as described in 604. For example, at least one element may be displayed on a display of the gaming machine may be an animated wheel that turns in response to the first input. The displayed element may represent a level of a game option that can be modified by the player.

The turning of the displayed element may correspond in real-time to the turning of the input device. For example, the number and speed of revolutions undertaken by the displayed element may be substantially the same as the input device.

In 612, the procedure may optionally test whether the input device has stopped turning. For example, the input device may generate a signal to indicate it has stopped turning. In an alternative embodiment, the input device may simply stop generate a signal indicating it is turn. The absence of this signal can be interpreted by the procedure to mean the input device has stopped turning. If yes, the procedure may proceed to 614, where a stop signal has been received by the procedure. If no, the procedure may wait until the input device has stopped turning.

In 614, the procedure may stop turning the displayed element. The displayed element may be statically displayed to the player.

In 616, the procedure may optionally test whether the input device has been pushed inwards. For example, the player may turn the input device to make his selection of a desired value for the game option, and press the input device inwards (similar to a button) to indicate he is finished with his selection.

In 618, the procedure may modify the game option in accordance with the player-selected value received in 616. For example, a game speed may be modified in accordance with the player's wishes. In an alternative embodiment, a game music volume may be modified in accordance with the player's wishes.

In 620, the procedure may end.

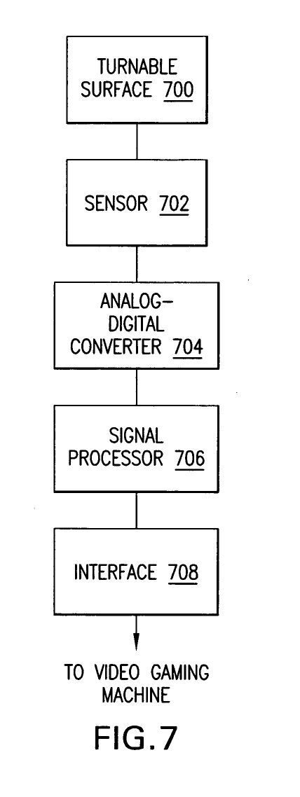

FIG. 7 illustrates an example system schematic of an input device with a turnable surface, in accordance with an example embodiment of the present invention. For example, the input device may be as depicted in FIGS. 1A, 1B, 2A, and 2B. The input device may be used in the system depicted in FIG. 3 and the video gaming machine depicted in FIG. 4. The input device may be used in the procedures depicted in FIGS. 5 and 6.

The input device may include a turnable surface 700. For example, the turnable surface 700 may be a wheel-shaped component configured to turn around an axis. In an alternative embodiment, the turnable surface 700 may be a barrel-shaped component configured to turn around an axis. For example, the turnable surface 700 may be symmetric and cylindrical to facilitate easy turning around the axis. However, it is understood that the turnable surface 700 may be neither symmetric nor cylindrical as long as it may be turned by the player.

The input device may include a sensor 702 proximate to the turnable surface 700. The sensor 702 may be configured to detect a motion in the turnable surface 700 and output an analog signal corresponding to the motion. For example, the analog signal may indicate a direction and magnitude of the motion.

The input device may include an analog-digital converter 704 in communication with the sensor 702. The analog-digital converter 704 may be configured to convert the analog signal received from the sensor 702 into a digital signal.

The input device may include a signal processor 706 in communication with the analog-digital converter 704. The signal processor 706 may be configured to process the digital signal into a signal that can be processed by a processor of a video gaming machine.

The input device may include an interface 708 in communication with the signal processor 706. The interface 708 may interface between the signal processor 706 and a network cable or other connection to the processor of the video gaming machine.

The procedure described may be stored as digital instructions for execution on a processor. The instructions may be stored on a computer-readable medium, such as a random access memory, a flash memory, a read-only memory, or any other medium accessible by a processor of a terminal.

### MODIFICATIONS

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A gaming terminal for a wagering game, comprising:
a turnable input device movably attached to the terminal, the turnable input device configured to provide a first input when turned by a player; and
a video display attached to the terminal, in communication with the turnable input device, the video display configured to display a turning element in the wagering game which turns responsive to the first input.

2. The gaming terminal of claim 1, wherein the terminal is configured to, responsive to receiving the first input, display the outcome of a wager made by the player.

3. The gaming terminal of claim 1, wherein the turnable input device is configured to provide a second input when the turnable input device stops turning, and the video display is configured to stop the turning element responsive to the second input.

4. The gaming terminal of claim 3, wherein the terminal is configured to determine an outcome of a wager made by the player and stop the turning element at a result indicative of the outcome.

5. The gaming terminal of claim 1, wherein the turning element is an animated turning wheel.

6. The gaming terminal of claim 1, wherein the turning element is a simulated slot machine reel.

7. The gaming terminal of claim 1, wherein the turning element is a simulated roulette wheel.

8. The gaming terminal of claim 1, wherein the displayed element is a simulated lock element.

9. The gaming terminal of claim 1, wherein the turnable input device is further configured to turn around an axis perpendicular to a surface of the terminal.

10. The gaming terminal of claim 1, wherein the turnable input device is further configured to provide a third input when pushed towards the terminal along an axis perpendicular to a surface of the terminal.

11. The gaming terminal of claim 1, wherein the first input modifies a game speed.

12. The gaming terminal of claim 1, wherein the first input modifies a game music volume.

13. The gaming terminal of claim 1, wherein the first input modifies a user selection of play lines in the wagering game.

14. The gaming terminal of claim 1, wherein the first input modifies a user selection of a wager amount in the wagering game.

15. The gaming terminal of claim 1, further comprising:
a payment acceptor configured to receive a payment from the player.

16. The gaming terminal of claim 1, further comprising:
a prize structure configured to associate game outcomes with prizes.

17. The gaming terminal of claim 1, further comprising:
a prize dispenser configured to award a prize to the player.

18. A method of facilitating play of a game of chance at a terminal, comprising:
receiving a first input indicating a player has turned a turnable input device; and
responsive to the first input, causing a displayed element on a video display to turn.

19. The method of claim 18, further comprising:
initiating resolution of a wager responsive to receiving the first input.

20. The method of claim 18, further comprising:
receiving a second input when the turnable input device stops turning; and
responsive to the second input, stopping the turning of the displayed element.

21. The method of 20, further comprising:
determining an outcome for the wager and wherein the displayed element is stopped on a result indicating the outcome.

22. The method of claim 18, wherein the displayed element is an animated turning wheel.

23. The method of claim 18, wherein the displayed element is an animated roulette wheel.

24. The method of claim 18, wherein the displayed element is a simulated slot machine reel.

25. The method of claim 18, wherein the displayed element is a simulated lock element.

26. The method of claim 18, wherein the turnable input device is configured to turn around an axis perpendicular to a surface of the terminal.

27. The method of claim 18, wherein the turnable input device is further configured to provide a third input when pushed towards the terminal along an axis perpendicular to a surface of the terminal.

28. The method of claim 18, wherein the first input modifies a game speed.

29. The method of claim 18, wherein the first input modifies a game music volume.

30. The method of claim 18, wherein the first input modifies a user selection of play lines in the wagering game.

31. The method of claim 18, wherein the first input modifies a user selection of a wager amount in the wagering game.

32. The method of claim 18, further comprising:
receiving a payment from the player at a payment acceptor.

33. The method of claim 18, further comprising:
determining a prize to be awarded by looking up a prize structure that associates game outcomes with prizes.

34. The method of claim 18, further comprising:
awarding a prize to the player from a prize dispenser.

35. A computer readable medium including instructions configured to be execute on a processor, so that the processor performs the steps of claim 18.
